(19) United States
(12) Patent Application Publication
(10) Pub. No.: US 2016/0104192 A1
(43) Pub. Date: Apr. 14, 2016

(54) ANTI-COUNTERFEIT METHOD FOR A SELF-SERVING RETAIL WEBSITE

(71) Applicant: Hong Li, Weihai (CN)

(72) Inventor: Hong Li, Weihai (CN)

(21) Appl. No.: 14/975,786

(22) Filed: Dec. 20, 2015

(30) Foreign Application Priority Data
Dec. 6, 2015 (CN) 2015109151764

(51) Int. Cl. G06Q 30/02

(52) U.S. Cl. CPC G06Q 30/0248

(57) ABSTRACT

Anti-counterfeit method for a self-serving retail website is by using software to check each new submission of seller's advertisement against a list of blocked brands and a list of approved sellers on the website, before it gets posted on the website.

### RELATED APPLICATION

This application is entitled to the benefit of China Patent Application Number 2015109151764, filed Dec. 6, 2015.

### TECHNICAL FIELD

The present invention relates to counterfeit software and online retail website.

### BACKGROUND

In a self-serving B2C retail website, many sellers can log in and post advertisement to sell products, and many buyers can search to find products they need and to purchase. While this kind of website can help millions of sellers to sell lots of products, it can also harbor massive counterfeit trade.

Monitoring counterfeit on the website manually or with software is often overwhelmed by millions of sellers and advertisements on the website. Whereas examining commerce items pierce by pierce to find counterfeit will be even more overwhelmed by massive quantity.

U.S. Pat. No. 8,374,920 describes an anti-counterfeit method on an auction website, in which each seller is required to provide a brand code and a product code of each item to be sold, along with the item specification to match with its product code such as class, model, size, color and so on, to post sale information of the item. If a brand code, a product code, and an item specification match those stored on the website when checked by software, then the sale information of the item will be approved for post.

There are shortcomings of the method. First, it is too much work to put in much information for each item to be sold. The method may be suitable for auction on a C2C website where trade volume is usually small for each seller, but not suitable for putting one advertisement to sell many types and many pierces of items on a B2C website. Second, the method will take up large memory of a website to store lots of brand codes, product codes and specifications, since each variation of product specification such as color, size and so on will have a different product code. Third, brand code and product code can be coped and counterfeited. Fourth, this method cannot fix sellers or limit numbers of sellers for each brand, nor monitor and control sellers. Fifth, the method will exclude sellers from selling products that is not a brand, but also not counterfeit. That will not be good for some sellers, buyers, and the website.

The present invention is to address the counterfeit problem in a self-serving B2C retail website.

### SUMMARY

The present invention provides an anti-counterfeit method for a self-serving retail website is by using an anti-counterfeit software to check each new submission of seller's advertisement against a list of blocked brands and a list of approved sellers on the website, to decide whether it is allowed to be posted or not.

### DESCRIPTION

According to the present invention, an anti-counterfeit method for a self-serving retail website is by using a computer software to examine each new submission of seller's advertisement before it gets posted on the website. The software will check whether a new submission contains a brand's information such as a name, sign, symbol, or picture stored on the website.

When a submission of a new or revised advertisement does not contain information of a brand which is on the list of blocked brands on the website, the software will approve the submission. When a new submission of advertisement contains information of a brand which is on the list of blocked brands on the website, but also the seller who made the submission is on the list of sellers approved to sell the blocked brand, the submission will also be approved. On the other hand, when a new submission of advertisement contains information of a brand which is on the list of blocked brands on the website, but the seller who made the submission is not on the list of sellers approved to sell the blocked brand, the submission will be rejected.

The list of blocked brands can be made based on public information. Also, a brand owner or an authorized seller for a brand can request its brand to be added onto the list of blocked brands, by supplying supporting document and information of it brand to the website office.

An authorized seller for a brand can request its name to be added to the list of approved sellers, by showing supporting document to the website office.

To hold sellers accountable for their products so that they will not sell fake products on the website, information of each seller is required for registration on the website, such as name, birth day, address, phone number, driver license, business license, social security number, credit card number, and bank account. The counterfeit software will check and verify the information against online record to approve registration on the website.

The method of the present invention has some important advantages.

First, by using the method, checking and approving new advertisement submitted will be much easier than monitoring all of advertisements posted on the website, because the sum of existing and new ones is always more than just new ones, and it is usually not necessary to reexamine the advertisements already approved and released.

Second, the method will have every advertisement examined before posted with no missing.

Third, by using the method, sellers of a brand can be fixed with limited numbers. Advertisements and products of a few fixed sellers for a brand can be monitored and controlled.

Fourth, by using the method, sellers do not need to authenticate their products on the website by putting in a lot of information such as brand codes, product codes and specifications.

Fifth, sellers could be allowed to sell products that is not a brand, but also not counterfeit. So the website can be inclusive to all the sellers that do not sell counterfeit.

When needed, the method mentioned above can be modified to only include brand products. In this case, a list of blocked brands and a list of approved sellers on the website will also be stored on the self-serving website. A software will examine each new submission of advertisement. Sellers who are not on the list of approved sellers will not be allowed to log into the website to submit advertisement. When an advertisement submitted does not contain information of a brand which is on the list of blocked brands on the website, the software will reject the submission. When an advertisement submitted contains information of a brand which is on the list of blocked brands on the website, but also the seller who made the submission is on the list of sellers approved to sell the blocked brand, the submission will be approved. On the other hand, when an advertisement submitted contains information of a brand which is on the list of blocked brands on the website, but the seller who made the submission is not on the list of sellers approved to sell the blocked brand, the submission will be rejected.

1. An anti-counterfeit method for a self-serving retail website is by using an anti-counterfeit software to examine each new submission of sell's advertise before it gets posted on the website. When a submission of a new or revised advertisement does not contain information of a brand which is on the list of blocked brands on the website, the software will approve the submission. When a new submission of advertisement contains information of a brand which is on the list of blocked brands on the website, but also the seller who made the submission is on the list of sellers approved to sell the blocked brand, the submission will also be approved. On the other hand, when a new submission of advertisement contains information of a brand which is on the list of blocked brands on the website, but the seller who made the submission is not on the list of sellers approved to sell the blocked brand, the submission will be rejected.

2. The method of claim 1 wherein the list of blocked brands can be made based on published information.

3. The method of claim 1 wherein a brand owner or an authorized seller for a brand can request its brand to be added onto the list of blocked brands, by showing supporting document to the website office.

4. The method of claim 1 wherein an authorized seller for a brand can request the seller name to be added on the list of approved sellers for the brand.

5. The method of claim 1 wherein information of a brand is selected from the group of name, sign, symbol, or picture, which are stored on the website.

6. The method of claim 1 wherein each new seller's information selected from the group of name, birth day, address, phone number, driver license, business license, social security number, credit card number, and bank account, will be required for registration, and will be checked by the anti-counterfeit software against online record to approve registration on the website.

7. An anti-counterfeit method for a self-serving retail website is by using an anti-counterfeit software to examine each new submission of sell's advertise before it gets posted on the website. Sellers who are not on the list of approved sellers will not be allowed to log into the website to submit advertisement. When an advertisement submitted does not contain information of a brand which is on the list of blocked brands on the website, the software will reject the submission. When an advertisement submitted contains information of a brand which is on the list of blocked brands on the website, but also the seller who made the submission is on the list of sellers approved to sell the blocked brand, the submission will be approved. On the other hand, when an advertisement submitted contains information of a brand which is on the list of blocked brands on the website, but the seller who made the submission is not on the list of sellers approved to sell the blocked brand, the submission will be rejected.
